(19) United States
(12) Patent Application Publication
(10) Pub. No.: US 2008/0228769 A1
(43) Pub. Date: Sep. 18, 2008

(54) Medical Entity Extraction From Patient Data

(75) Inventors: Lucian Vlad Lita, San Jose, CA (US); Ciprian Dan Raileanu, King of Prussia, PA (US); Radu Stefan Niculescu, Malvern, PA (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/047,416

(22) Filed: Mar. 13, 2008

Related U.S. Application Data
(60) Provisional application No. 60/918,205, filed on Mar. 15, 2007.
(60) Provisional application No. 60/895,545, filed on Mar. 19, 2007.

(51) Int. Cl. G06F 7/06; G06F 17/30

(52) U.S. Cl. 707/6; 707/3; 707/E17.017

(57) ABSTRACT

Members of a medical entity class are extracted from patient data. A semi-supervised approach uses one or more initial medical terms such as terms from an ontology, for a given category or medical canonical entity. A larger set of medical terms is extracted from the medical information. In one example, the extraction is performed using lexical surface form features, rather than syntactical parsing.

### RELATED APPLICATIONS

The present patent document claims the benefit of the filing date under 35 U.S.C. §119(e) of Provisional U.S. Patent Application Ser. Nos. 60/918,205, filed Mar. 15, 2007, and 60/895,545, filed Mar. 19, 2007, which are hereby incorporated by reference.

### BACKGROUND

The present embodiments relate to determining terms associated with a medical canonical entity.

Medical transcripts are a prevalent source of information for analyzing and understanding the state of patients. Medical transcripts are stored as text in various forms. Natural language is a common form. The terminology used in the medical transcripts varies from patient-to-patient due to differences in medical practice, even for the same disease. The variation and use of medical terminology requires a trained or skilled medical practitioner to understand the medical concept relayed by a given transcript, such as indicating a patient has had a heart attack. These sources of unstructured data have been underused due to the requirement for a manual analysis by a trained person, yet medical transcripts very often encode critical information not present in tabular form.

Automated analysis of medical records is difficult. Medical text (such as physicians' notes) is highly unstructured, does not follow strict grammatical structures, may include misspellings, may have unusual or varied format, may include irregular punctuation, and is usually different from open-domain text, such as news articles. The unstructured nature of the free text and the various ways used to refer to the same medical condition (e.g., disease, event, symptom, billing code, standard label, or user specific reference) make automated analysis challenging. All of these difficulties are exacerbated in medical text compared to much cleaner free text typically used when testing natural language processing algorithms.

One approach is phrase spotting, such as searching for specific key terms or phrases in the medical transcript. The existence of a word or words is used to show the existence of the state of the patient. The existence of the word or words may be used with other information to infer a state, such as disclosed in U.S. Published Application No. 2003/0120458. Rules are used to determine the contribution of any identified word to the overall inference. Certain conditions may be only implied through a reference to related symptoms or diseases and never mentioned explicitly. The mere presence or absence of certain phrases or words immediately associated to the condition may not be enough to infer the condition of patients with high certainty.

Knowledge resources are very often incomplete, and concepts are usually incorporated in ontologies only in their canonical form. Paraphrases, compound concepts, and concepts that incorporate critical modifiers are notoriously absent from the majority of knowledge resources. Because of this, information extraction based solely on knowledge bases may be insufficient and may not indicate reliability of the extracted information.

Natural language processing (NLP) methods have started to permeate the medical field and tackle the problems of medical entity extraction and classification. Typical existing approaches to medical information extraction involve large knowledge bases and medical ontologies, which are directly used for extraction in free text, such as matching existing ontology nodes in patient records. However, these knowledge sources are very often incomplete and more importantly only include simple entities in canonical form. In reality, entities often i) occur in free text as rephrasing of canonical forms (e.g. symptoms chest pain vs. pain in his chest), ii) contain additional critical information (e.g. symptom frequent mild chest pain on exertion), iii) appear as a compound concept (e.g. symptom pain or tingling sensation in shi legs), or iv) are descriptive rather than exhibiting ontological exactitude (e.g. symptom: frequent acute pain in the lower right leg). Medications, procedures, test results, symptoms, or other canonical entities may use similar terminology, resulting in difficulty distinguishing the terms.

For rule-based processing, multiple people spend considerable time manually creating large numbers of textual patterns for information extraction. The major problems with rule-based approaches are 1) a lack of generalization of hand-written rules, 2) maintainability of the rule-set, and 3) portability when transferring the rules to a new site or domain. In terms of maintainability, once several hundred rules are hand-written, it becomes very difficult to predict how the rules will interact for a given task. Over time, when more free text is processed, new contexts and grammatical constructs are encountered, making it very difficult to adapt an existing set of rules. Moreover, the rules are usually tailored for a particular hospital, or for a specific department (e.g. cardiology). When porting the extraction tool to a new hospital or department, a considerable percentage of the rule set has to be re-written, thereby duplicating the work and taking almost as long as the original effort.

Another approach to NLP in news stories is modeling. During the past twenty years, the field of information extraction has advanced to the point where high performance systems are based on statistical models trained on large text collections. While word-sense ambiguity is drastically reduced due to the domain specific nature of the task, electronic patient records lack the syntactic correctness present in the news story domain that has been extensively used in NLP. At the same time, the degree of noise and site specificity (e.g. hospital-specific annotations) presents difficulties to trained extractors.

Supervised methods to information extraction include a combination between hidden Markov models and language modeling approach for named entity extraction, conditional random fields for sequence data labeling in general English text, and biomedical text. However, supervised methods require substantial manual input of training data.

Unlabeled examples have been used in information extraction to improve named entity classification performance. The objective is to start with a small amount of labeled examples and use a free text corpus to retrieve additional entities from the same class. Additional entity extraction approaches include a semi-supervised syntax-based method, as well as an unsupervised method for extracting entities from the Web. Similarly, semantic lexicons may be built by employing a bootstrapping method. However, these approaches generally use relative non-noisy data sets, such as news articles.

### SUMMARY

In various embodiments, systems, methods, instructions, and computer readable media are provided for extracting members of a medical entity class from patient data. A semi-supervised approach (i.e. uncovering structure and class membership of free-ext elements using only a very small set of examples) uses one or more initial medical terms, such as terms from an ontology, for a given category or medical canonical entity. A larger set of medical terms is extracted from medical information. In one example, the extraction is performed using lexical surface form features, rather than syntactical parsing.

In a first aspect, a system is provided for extracting members of a medical entity class from patient data. An input is operable to receive identification of at least a first member of the medical entity class. A processor is operable to extract at least a second member of the medical entity class from the patient data. The extraction is a function of the first member, and the extraction is a semi-supervised process operable to identify the second member from the patient data for a plurality of patients. At least some of the data subjected to the semi-supervised process is free text with medical information related to symptoms, medication, test result, condition, disease, or combinations thereof. A display is operable to output a listing of members of the medical entity class. The members are the at least first member and the at least second member extracted by the processor as a function of the first member.

In a second aspect, a computer readable storage medium has stored therein data representing instructions executable by a programmed processor for identifying a set of words or phrases for a canonical entity. The instructions include receiving at least one initial word or phrase; identifying the set with lexical surface form features from free text without syntactical parsing of the free text (the identification procedure is a function of the at least one initial word or phrase); and outputting the set.

In a third aspect, a method is provided for extracting members of a medical canonical entity from patient data including free text. Free text is received as natural language information from medical professionals for a plurality of patients. The information includes a misspelling, non-grammatical format, different formats, or combinations thereof. One or more seed medical terms are received. The one or more seed medical terms are one or more members of the medical canonical entity. Context for the one or more seed medical terms in the free text is determined free of syntactical parsing. Additional medical terms are identified as a function of the context in the free text. A list of the members of the medical canonical entity is generated as at least some of the additional medical terms and the seed medical terms.

Any one or more of the aspects described above may be used alone or in combination. These and other aspects, features and advantages will become apparent from the following detailed description, which is to be read in connection with the accompanying drawings. The present invention is defined by the following claims, and nothing in this section should be taken as a limitation on those claims. Further aspects and advantages are discussed below in conjunction with the preferred embodiments and may be later claimed independently or in combination.

### BRIEF DESCRIPTION OF THE DRAWINGS

FIG. 1 is a flow chart diagram of one embodiment of a method for extracting members of a medical canonical entity from patient data including free text;

FIG. 2 is a graphical representation of added instances for a condition through iteration in one embodiment;

FIG. 3 is a graphical representation of added instances for a medication through iteration in one embodiment;

FIG. 4 is a graphical representation of precision per iteration for the condition and medication of FIGS. 2 and 3;

FIG. 5 is a graphical representation of an impact of starting set size on the number of extracted conditions; and

FIG. 6 is a block diagram of one embodiment of a system for extracting members of a medical entity class from patient data.

### DESCRIPTION OF EMBODIMENTS

Complex and non-complex entities and their reformulations (e.g., paraphrases) are extracted from free text. Different critical information is captured for different entity classes. The automatic, data-driven methods are capable of extracting complex concepts of the medical canonical entities. Through the process of acquiring entity occurrences (instances) from free text, entity taggers have access to the more complex training data for building better models.

To extract members of a canonical entity, semi-supervised methods identify complex medical entities (medication, diseases, symptoms, or others) which include relevant modifiers, compound structures, and paraphrases. The entities are identified from electronic patient records, along with building an extended medical class lexicon. The approaches have high precision, but still cover a large set of the entity instances present in medical corpora.

The semi-supervised approach extracts extended entities from free medical text, such as noisy patient records, using single or a few initial terms. The algorithm can extract a large, high precision domain specific set of entities starting from different size existing knowledge sources. The extraction process, which may be performed automatically without any human involvement, incrementally incorporates new concepts that are part of the same class.

Data driven approaches may automatically discover new members of a target concept using one or more iterative algorithms. The algorithms may be based on different assumptions, such as co-occurrence and context similarity assumptions. Members of medical concepts such as symptoms, medications, diseases, and medical tests are automatically extracted from large amounts of unstructured or free text (such as physicians' notes, medical publications, etc.). The algorithms learn how different concept classes occur in large amounts of free text. The algorithms can be used to find compound concepts, context for concepts, instances of concepts, concepts with useful modifiers (e.g. symptoms together with attributes such as frequency of occurrence, trigger activity, time when it happened, acuteness of the symptom, or others), and new concepts that cannot be found simply from looking in knowledge resources, such as UMLS, MESH, or WordNet. These approaches may be used to extract extended concepts that incorporate additional relevant information that other algorithms usually do not identify in text (e.g. identifying frequent chest pain vs. rare chest pain vs. chest pain).

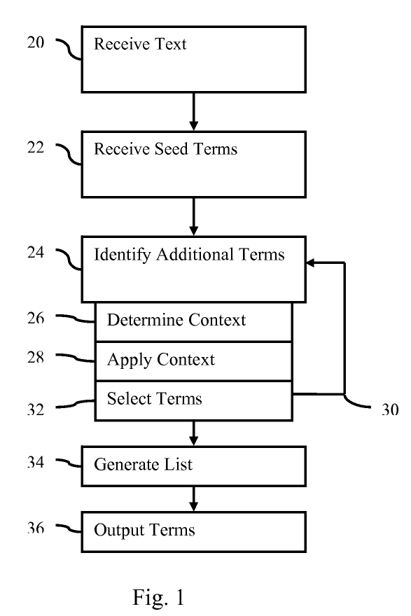

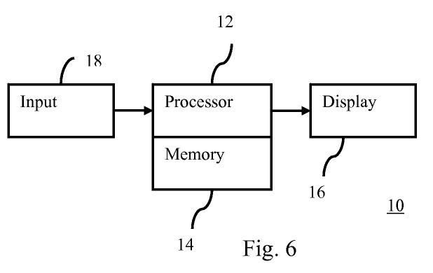

FIG. 1 shows one embodiment of a method for extracting members of a medical canonical entity from patient data including free text. The method is implemented with the system of FIG. 6 or a different system. The acts are performed in the order shown or a different order. Additional, different, or fewer acts may be provided. For example, acts 24-28 are performed without acts 32 and 32.

In act 20, free text is received. The data is medical data, such as medical transcripts and/or patient records. Medical transcripts may be unstructured, natural language information. The text passages may be formatted pursuant to a word processing program, but are not data entered in predefined fields, such as a spreadsheet or other data structure. Instead, the text passages represent words, phrases, sentences, documents, collections thereof, or other free-form text. The natural language information is for a plurality of patients. Due to differences in practice, data entry technique, language usage, format, or other reasons, the information may include a misspelling, non-grammatical format, different formats, combinations thereof, or other natural language phenomenon introducing noise in the data set as compared to news text.

The text passages are from a medical professional, such as a physician, lab technician, imaging technician, nurse, medical facility administrator, or other medical professional. Patient log entries may be included. The text passages include medical related information, such as comments relevant to diagnosis of a patient or person being examined or treated. For example, text passages may be medical transcripts, doctor notes, lab reports, excerpts there from, or combinations thereof. The text may or may not deal with a given medical canonical entity, such as symptoms, medications, or conditions. In alternative or additional embodiments, other data, such as tabulated data, news text, or structured data, may be received as part of the patient information.

The received medical data is a corpus, C, of data. For example, the corpus includes electronically stored patient records (e.g., progress notes) from a physician, hospital, database, or other collection of medical data related to one or more (e.g., tens, hundreds, or thousands) patients. The corpus may include one or more entries or instances associated with a target concept, TC. For example, the records for a subset of patients deal with medical conditions, medications, specific disease, specific medication, or other canonical medical entity.

In act 22, one or more seed medical terms are received. The terms are received from a user, such as the user selecting or entering one or more terms. Alternatively or additionally, the terms are extracted from a knowledge base, such as an ontology, by a user or processor. In other embodiments, the terms may be extracted automatically from an unsupervised algorithm for the target concept.

The medical terms are a word or phrase. For example, aspirin, heparin, insulin, morphine, norvasc, penicillin, Tylenol®, and zofran are word medical terms for the medication target concept. As another example, chills, cough, dizziness, fatigue, fever, headache, nausea, and rashes are word medical terms for the condition target concept. In another example, strong headache, slight dizziness, drug contraindication, or other phrases are used as medical terms.

Any number or combination of words and/or phrases may be used. The medical terms may be selected in order to focus on a given entity, such as terms associated with heart disease. The selected medical terms are members of the target concept or medical canonical entity of interest.

The medical terms received in act 22 are an initial set of one or more terms. The medical terms are the beginning members used in a semi-supervised process to identified additional members of the target concept. For example, A₀ is an initial set of member phrases belonging to a target concept TC. The initial set has any number of members, such as a small set of 2-10 members (e.g., A₀ is the subset {“nausea”, “chest pain”}). The semi-supervised algorithm may be initialized with very few known members of a concept (e.g. symptoms, medications, diseases), but can accommodate larger sets of known members, such as members of a concept extracted from an ontology (e.g. UMLS, MESH). Other sources of the initial members of the target concept may be used, such as an expert, a medical professional, a procedure, a guideline, or mutual information criteria processing or learning. The initial medical terms to be used for learning other members are known or given before learning.

In act 24, additional medical terms are identified. The additional medical terms are for the same target concept. One or more further medical terms are identified. The further terms are identified by a processor applying an algorithm. Terms with a same or similar context as the initial or seed terms are identified. Any now known or later developed algorithm may be used to identify additional terms with a same or similar context as the seed terms. Two example algorithms using co-occurrence or context similarity are provided below. Text mining automatically discovers as many members as possible of the target concept TC by intelligently taking advantage of the small initial set, A₀, of terms, and the corpus, C, of free text or other patient information.

In act 26, the context associated with the seed medical terms is determined. The seed medical terms are identified in the free text or other medical records, such as by word searching. Derivatives, such as plural versions, of the seed terms may be identified.

The context within the medical record associated with each seed term is determined. The context may be syntactical, such as parsing the text with grammatical labels. In other embodiments, the context is identified with lexical surface form features from free text without syntactical parsing of the free text. The determination is free of syntactical parsing. Since medical data may be noisy, lexical surface form features (words with or without punctuation and free of syntax labeling) may more likely provide usable context.

For example, the co-occurrence of other medical terms with one or more seed terms is determined. A list including the seed terms or initial word or phrase is identified. Phrases belonging to the same target concept tend to appear in lists consisting of several of the phrases. The set of members belonging to the target concept is expanded by looking in the free text corpus C for lists that contain the currently discovered members (e.g., the seed medical terms) of the target concept. For example, assume that the corpus C contains the phrases “the patient has nausea, vomiting, and hives” and “the patient denies any chest pain, vomiting, or nausea.” If nausea and/or hives are known or initial members of the target concept relative to a current iteration, the terms “vomiting” and “chest pain” are identified as having a co-occurrence context for the target concept by being in a same list as the seed terms.

The co-occurrence context may be identified in any desired manner. For example, comma separation of the medical terms adjacent to the seed term is identified. Neighbor terms separated by a comma from the seed term indicate a list. The neighbor term immediately precedes or follows the seed term. As another example, a list of conjunction terms (e.g., and, or, nor, . . . ) is searched within a set number of words from the seed term. The conjunction term does not require syntactical parsing since the terms are merely used as search terms and the grammatical relationship with other terms is not needed. In another example, both comma separation and the use of a conjunction term are used to identify a same context. For more exacting context, a colon may be required.

As another example for determining context, similarity in usage is determined. A prefix phrase, a suffix phrase, or both associated with each instance of a seed term is identified. Phrases belonging to the same target concept tend to appear in similar contextual patterns, such as similar snippets of text delimited by punctuation marks around these phrases. Prevalent contextual patterns in which the seed medical terms occur are identified.

The context similarity may be identified in any desired manner. The prefix and/or suffix phrase may be limited, such as by number of words. In one embodiment, the prefix and suffix are limited by identifying a clause delimited by punctuation and including a seed medical term. For example, assume the text corpus C contains the following sentences: “the patient denies any chest pain” and “the patient denies any chills.” In a first iteration, the algorithm uncovers the contextual pattern <the patient denies any>+Symptom+< > where the symptom is the seed term “chest pain” and “chills” is not a current seed or initial term. Next, this pattern is applied on the corpus and “chills” is extracted as a new member to add to Symptoms. Phrases without or with any prefix or suffix may be used.

In act 28, the context is applied to identify additional medical terms, words or phrases. The additional terms are identified from the free text. The same or different corpus is used. The application is a semi-supervised operation. The initial or seed terms are supplied to the algorithm. After determining the context with the initial or seed terms, further terms are identified by the algorithm without further user input. Some user input may be provided, such as to adjust limitations, thresholds or other settings of the algorithm.

In the co-occurrence context, other words or phrases in a list with the seed terms are identified. The set of current terms is populated with the seed terms and the additional terms from the lists in the free text. For example, a string of terms including at least one of seed medical terms is identified as a function of commas and a conjunction term. Any terms in the string not already part of the current terms are added or considered a possible members.

One example co-occurrence algorithm is provided below, but other co-occurrence algorithms may be used. The set, A₀, of members provided initially for the target concept are input and defined as the current members A. The algorithm is applied iteratively. STEP 1: Initialize k←0, the iteration step, and initialize A←Ø, the set of members corresponding to the target concept TC. STEP 2: A←A U Aₖ, k←k+1. STEP 3: parse the free text corpus C using regular expressions (e.g., “[x], [x], [x][,] [and/or] [x]”) to recognize all the lists of items that contain any elements of A. Let Aₖ be the set of all items outside A found inside these lists that appear with a frequency higher than a threshold frequency τ. STEP 4: if Aₖ=Ø, TERMINATE. Else GO TO STEP 2. STEP 3 is repeated, adding new members that co-occur in textual lists with the current members, until there are no more members to be added. The lists are extracted from free text patient records using a sentence-based robust list identifier and parser.

In the similarity context, other words or phrases with a same or similar prefix phrase, suffix phrase or both are identified. Additional medical terms having a same or similar prefix phrase, suffix phrase or both indicate other members of the canonical entity. Once these contextual patterns are uncovered, they are applied as regular expressions to discover new members of the target concept. For example, other terms in a clause delimitated by punctuation with a similar or same context are added to the set.

One example context similarity algorithm is provided below, but other context similarity algorithms may be used. STEP 1: initialize k←0, the iteration step, and initialize A←Ø, the set of members corresponding to the target concept TC. STEP 2: A←A U Aₖ, k←k+1. STEP 3: parse the free text corpus C to generate all the contextual patterns of the form CP—(prefix) (p_{A}) (suffix) where suffix and prefix are snippets of text and p_{A} stands for any term in A. The one of the prefix or suffix may not have any terms or may include punctuation. Other limits may be placed on the context, such as at least one of the suffix or prefix having at least a threshold number of words. Let ττ(CP) be the number of times the contextual pattern CP matched in the corpus. STEP 4: keep the n (e.g., top 10) contextual patterns with the highest values of τ(CP) and then apply these patterns in the corpus to find alternative phrases p that appear instead of p_{A} with the same prefix and suffix. Let Bₖ be the set of all such phrases outside A. Let Aₖ be the subset of Bₖ consisting of those phrases for which the contextual patterns were matched with a frequency higher than a threshold frequency τ. STEP 4: if Aₖ=Ø, TERMINATE. Else GO TO STEP 2. Only the suffix or only the prefix may be used. Any clause demarcation, such as punctuation or number of words, may be used. In STEP 3, the contextual patterns in which the current members of the target concept occur are found.

In one embodiment, strict limitations on context deviation are used. For example, a colon followed by terms separated by commas and a final conjunction term must be identified to qualify as a list string. In other examples, the colon is not required and/or the number of words in between adjacent commas is limited. The limitations may limit the number of actual lists found, such as finding about ¼ of the lists. As another example, the derivative words used in the prefix or suffix may be limited, such as using exact matching. Common substitutions may or may not be accounted for in the prefix or suffix phrases (e.g., allowing substitution of “a” for “the”). The limitations may result in better precision performance. In other embodiments, less exacting limitations are used, such as where the corpus of medical records is smaller.

The context-based algorithm may not be iterative. In the two examples above, the algorithms are iterative. Iteration is represented in FIG. 1 by the feedback act 30. For each iteration, the current members of the target concept are used as the initial or seed terms. The identification of additional terms and/or context is performed for each iteration using the set from a previous iteration as the initial words or phrases. Any given iteration may be limited to newly added members. The determination of context is performed for the new terms to extract additional terms. The process repeats until no additional terms are identified in an iteration, until a threshold number of iterations has occurred, until a threshold number of members is identified, or until another occurrence.

In act 32, words or phrases identified as possible words or phrases of the set are selected. All of the additional terms may be selected. In other embodiments, a subset of the additional terms is selected. The selection occurs for each iteration. Selection of a subset may prevent the addition of terms more general than the target concept. Alternatively, selection occurs after termination of the algorithm.

Any criteria for selection may be used. For example, the elements of these lists that have not been added already and which occur a “reasonable” number of times are added. “Reasonable” may be any threshold, such as more two, five, or other number. Only one candidate may be selected in another embodiment, such as a candidate member with a highest probability of being a member of the target concept. Probability may be determined by frequency of occurrence with other members of the target concept. Alternatively, “reasonable” is an adaptive threshold to account for different size corpuses. For example, a subset of the additional medical terms identified in each iteration is selected as a function of frequency ratios of the additional medical terms. The number of occurrences of the possible additional term in the context of interest divided by the number of occurrences of the same context without the possible additional term indicates a frequency ratio. If the frequency ratio is sufficiently large (e.g., 0.5), the probability of the possible additional term being a member of the target concept is better. Other ratios may be used. Any frequency-based heuristic may be used to determine which of the new matches of the patterns are added to the target concept. As another example, the most frequent, such as the five most frequent candidates or the candidates in the upper X % of the list, are added. Candidates that appear in many lists are more likely to be members of the target concept, and candidates that appear very few times are most likely not to belong to the target concept. Precision may be used for the selection criteria. In another embodiment, recall is used, such as applying a numeric threshold. This threshold permits pruning such that the new entities (symptoms, medications, or others) have a higher likelihood of having the same class membership with the seed. This parameter (threshold) takes another step towards ensuring generalization power, forcing the new examples to have a modicum of similarity to the seed set.

In the two example algorithms discussed above, the selection criteria are incorporated by the parameter τ. For example, the co-occurrence algorithm uses the parameter τ to control the “quality” of potential candidates. As another example, the similarity context also uses the parameter τ. Small frequency values τ(CP) are less likely to generalize. In STEP 4, the parameter n is used to discard this kind of pattern. n represents the top 10% or a threshold number (e.g., top 10 terms) of terms. The selection may increase speed and precision since most of the patterns generated may not be general enough. Consequently, the new candidates are also filtered based on a frequency threshold τ. Even though the remaining patterns are matched a significant number of times, the newly generated candidates based on the corresponding prefixes and suffixes might appear only a few number of times. There is less confidence that the candidates are actual members of the target concept. Other selection criteria may be used.

In another embodiment, each possible member is assigned a scoring function. If the score is above a threshold, the member is included in the set. The members used to identify further members may be a subset of all current members. For example, a function representing entity endorsement for the class of interest is calculated for each member and the highest member or sufficiently highly rated members are used for identification.

In act 34, a list is generated. The list is the output from the identification. The list includes the members of the medical canonical entity. The original seed medical terms and any additional terms identified by context from the medical data are included in the list.

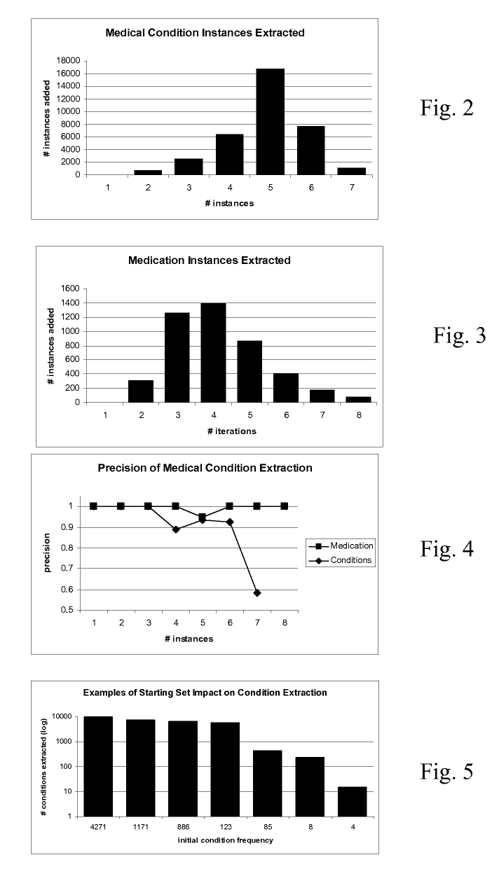

The list may have any precision. In one embodiment, the precision is at least about 0.80, 0.85, or 0.90 through five iterations. FIGS. 2-5 show results associated with applying the co-occurrence (colon, comma separation, and conjunction with τ being 10) and the similarity context (punctuation delaminated clause using both prefix and suffix exact matching with τ being 5 and n being 10). The corpus is 700K instances of progress notes for a population of more than 200K cardiac patients seen at a large heart hospital. The precision (i.e., the percentage of occurrences of discovered members that truly belong to the target concept) is evaluated.

FIG. 2 shows the number of instances of the current members of the target concept added per iteration by the co-occurrence algorithm. The target concept is medical conditions. The experiments are based on using a seed set including four members: nausea, vomiting, chest pain, and fever. FIG. 3 shows the number of instances of the current members of the target concept added per iteration by the co-occurrence algorithm, where the target concept is medications. As shown in FIGS. 2 and 3, the co-occurrence algorithm starts slowly, conservatively adding a small number of new items in the first couple of iterations. The algorithm peaks after a few more iterations and then the number of new items sharply decreases. As seen in these figures, the co-occurrence algorithm tends to converge in very few iterations.

FIG. 4 shows the per iteration precision of the newly added instances by the co-occurrence algorithm for medical conditions and medications. The overall precision for the final set of target concept items is 0.905 (for conditions) and 0.993 (for medications). Most of the noise in the medical condition target concept class may be attributed to medical procedures mistaken for medical conditions.

FIG. 5 shows a per item impact of the starting set size on the number of newly acquired items (log-scale) using the similarity context algorithm. The frequency of a term in the corpus C affects the number of items generated when given as the single seed to the similarity algorithm. The horizontal axis displays seven medical conditions in the decreasing order of their frequencies in the corpus. The vertical axis displays the number of items generated by each of these conditions after one iteration of the similarity algorithm. The graph in the figure suggests that the more frequently occurring an initial item is in the corpus, the more candidates will be generated. n=10 is used to select the 10 most frequent contextual patterns, and a threshold of τ=5 is used to generate new members of the target concept “medical condition.” Using an initial set of randomly chosen five medical conditions, the algorithm had a computed precision of 0.872, or about 0.9.

The different target concepts may be associated with different sources of noise. For example, symptoms may be interleaved with illness or parts of the body, and medication lists may include medical procedures, symptoms, conditions, or body parts. Precision may be different for different target concepts.

In act 36, the set is output. For example, the list is displayed. The output is to a display, to a printer, to a computer readable media (memory), or over a communications link (e.g., transfer in a network). The output may include additional information. For example, excerpts (e.g., identified lists, specific instances, or prefixes and suffixes) from the medical data are identified or also provided. As another example, the frequency information associated with each term is output.

In one embodiment, the members of the set are output to another process. For example, the set may be output for use by the same or different processor for training a model. The set is used as an input of a machine learning process to model patient states from medical records. The members of the sets indicate variables as possible candidates to predict patient state. The machine learning then identifies the strongest terms to indicate patient state given the corpus for learning.

FIG. 6 shows a block diagram of an example system 10 for extracting members of a medical entity class from patient data. The system 10 implements the method of FIG. 1 or other methods.

The system 10 is a hardware device, but may be implemented in various forms of hardware, software, firmware, special purpose processors, or a combination thereof. Some embodiments are implemented in software as a program tangibly embodied on a program storage device. The system 10 is a computer, personal computer, server, PACs workstation, imaging system, medical system, network processor, network, or other now know or later developed processing system. The system 10 includes at least one processor (hereinafter processor) 12 operatively coupled to other components. The processor 12 is implemented on a computer platform having hardware components. The other components include a memory 14, a network interface, an external storage, an input/output interface, a display 16, and a user input 18. Additional, different, or fewer components may be provided.

The computer platform also includes an operating system and microinstruction code. The various processes, methods, acts, and functions described herein may be part of the microinstruction code or part of a program (or combination thereof) which is executed via the operating system.

The processor 12 receives or loads medical information, such as a corpus of medical transcript information. Medical transcripts include text passages, such as unstructured, natural language information from a medical professional. Unstructured information may include ASCII text strings, image information in DICOM (Digital Imaging and Communication in Medicine) format, or text documents. The text passage is a phrase, group of words, sentence, group of sentences, paragraph, group of paragraphs, document, group of documents, or combinations thereof. The text passages are for a plurality of patients. Text passages for any number of patients may be used. The free text of the text passages is natural language information from a medical professional. The information may include misspellings, non-grammatical formats, different formats, or combinations thereof.

Header and footer metadata may be removed before processing. Other common information adding noise may be removed. Duplication on a sentence, paragraph, or document level may be removed to avoid influencing the frequency counts. Common terms may be replaced, such as replacing “he,” “she,” and “it” with PRN.

The user input 18 is a mouse, keyboard, track ball, touch screen, joystick, touch pad, buttons, knobs, sliders, combinations thereof, or other now known or later developed input device. The user input 18 operates as part of a user interface. For example, one or more buttons are displayed on the display 16. The user input 18 is used to control a pointer for selection and activation of the functions associated with the buttons. Alternatively, hard coded or fixed buttons may be used.

The user input 18, network interface, or external storage may operate as an input operable to receive identification of the medical information. For example, the user selects text passages by identifying a database. As another example, a stored file in a database is selected in response to user input. In alternative embodiments, the processor 12 automatically processes text passages, such as identifying a collection of text passages and processing them.

The selected data is to be subjected to a semi-supervised, unsupervised, or other process. The medical data includes free text with medical information related to symptoms, medication, test result, condition, disease, combinations thereof, or other medical entity classes.

The user input 18, network interface, or memory may operate as an input for the initial or seed members in a semi-supervised process. For example, the user types or selects one or more terms associated with a target concept (medical entity class) of interest. As another example, terms from an ontology are loaded from memory, transferred from a network interface, or selected by the user.

The processor 12 has any suitable architecture, such as a general processor, central processing unit, digital signal processor, application specific integrated circuit, field programmable gate array, digital circuit, analog circuit, combinations thereof, or any other now known or later developed device for processing data. Likewise, processing strategies may include multiprocessing, multitasking, parallel processing, and the like. A program may be uploaded to, and executed by, the processor 12. The processor 12 implements the program alone or includes multiple processors in a network or system for parallel or sequential processing.

The processor 12 performs the workflows, algorithms, and/or other processes described herein. For example, the processor 12 or a different processor is operable to extract terms for use in modeling or other uses. One or more members of a medical entity class are extracted from the patient data. In a semi-supervised process, one or more new members are identified by the processor 12 as a function of one or more initial or seed members. Syntax parsing may be used. Alternatively, the semi-supervised process uses lexical surface form features and/or is free of syntactical parsing. Any process may be used. For example, the semi-supervised process identifies new members as being in a list with an initial member. As another example, the semi-supervised process identifies the new members as being in a similar contextual pattern as the first member.

In another example, more than one process is performed, such as performing both co-occurrence and similarity context processes. The plurality of processes operate independently of each other, and the output sets of members are combined. Alternatively, new members from any process are passed to be used as seed or initial members in a further iteration of others of the processes.

The processes operate once or are iterative, such as looping to identify further members by using recently or processor 12 determined members as seed or initial members for the next iteration. The newly identified members may be included or excluded using any or no criteria. For example, some of the new members are deselected. Any heuristic may be used, such as frequency of occurrence, relative frequency as compared to other members, frequency ratio, exclusion rules (e.g., do not include term “x”), a threshold number of members, or amount of difference from an ideal context.

The display 16 is a CRT, LCD, plasma, projector, monitor, printer, or other output device for showing data. The display 16 is operable to output to a listing of members of the medical entity class. The members include any initial members provided to the processor 12 and any new members extracted by the processor 12. More than one list may be output. For example, a list for a given target concept may be separated into higher and lower probability terms. As another example, one or more lists may be output for each of a plurality of different target concepts.

As an alternative or in addition to output on the display 16, the list or member terms are stored, transmitted, or used in another process. For example, the processor 12 or another processor creates a model from the patient data where the model is for determining a patient state. The creation is by machine learning as a function of the members. The members or instances associated with the members may be input into the learning process. Entity taggers may have access to more complex training data for building the model. The display 16 may output the patient state for one or more patients after applying the learned model and/or model information. In another embodiment, the list is used to form or program a knowledge base for data mining and/or modeling.

In one embodiment, the list extraction is an extraction layer for further data mining and/or classification, such as disclosed in U.S. Published Patent Application No. 2003/0126101. The classification is used as a second opinion or to otherwise assist medical professionals in diagnosis. The extracted list may assist in probability determination for forming or training a knowledge base. The extraction layer may further assist in other classifiers, such as used for quality adherence (see U.S. Published Application No. 2003/0125985), compliance (see U.S. Published Application No. 2003/0125984), clinical trial qualification (see U.S. Published Application No. 2003/0130871), billing (see U.S. Published Application No. 2004/0172297), and improvements (see U.S. Published Application No. 2006/0265253). The disclosures of these published applications referenced above are incorporated herein by reference.

The same process or processes may be implemented using different data sets. For example, different medical institutions (offices, hospitals, insurance agencies, accreditation organizations, or agencies) may run the process on appropriate data sets. Different original seeds terms may be used for the same or different corpus. Due to these and/or other differences (e.g., different algorithms, algorithm settings and/or different term usage), the resulting lists may be different. The lists may be maintained and used separately. Alternatively, the different lists may be combined to create a more comprehensive listing. The processes may be applied with different amounts of data (e.g., different numbers of patient medical records) and/or different original numbers of seed members, providing versatility and possible use even for smaller institutions.

The processor 12 operates pursuant to instructions. The instructions and/or patient records for identifying a set of words or phrases for a canonical entity are stored in a computer readable memory 14, such as an external storage, ROM, and/or RAM. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method acts depicted in the accompanying figures may be implemented in software, the actual connections between the system components (or the process steps) may differ depending upon the manner of programming.

The same or different computer readable media may be used for the instructions, the patient records, text passages, and the initial or seed terms. The patient records are stored in the external storage, but may be in other memories. The external storage may be implemented using a database management system (DBMS) managed by the processor 12 and residing on a memory, such as a hard disk, RAM, or removable media. Alternatively, the storage is internal to the processor 12 (e.g. cache). The external storage may be implemented on one or more additional computer systems. For example, the external storage may include a data warehouse system residing on a separate computer system, a PACS system, or any other now known or later developed hospital, medical institution, medical office, testing facility, pharmacy or other medical patient record storage system. The external storage, an internal storage, other computer readable media, or combinations thereof store data for at least one patient record for a patient. The patient record data may be distributed among multiple storage devices.

The application of the process to identify members may be run using the Internet. The results or list may be accessed using the Internet. The extraction may be run as a service. For example, several hospitals may participate in the service to have their patient information mined for terms. The service may be performed by a third party service provider (i.e., an entity not associated with the hospitals). Based on a per-use license, a periodically paid license, or other payment, the output list may be compared or otherwise made available.

In embodiments above, a graphical model is provided for list extraction. Manually annotated data is not needed. Instead, one or several positive examples from a class of interest and a medical corpus are input. Manual intervention over the course of execution may be avoided.

Various improvements described herein may be used together or separately. Any form of data mining or searching may be used. Although illustrative embodiments have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for extracting members of a medical entity class from patient data, the system comprising:
an input operable to receive identification of at least a first member of the medical entity class;
a processor operable to extract at least a second member of the medical entity class from the patient data, the extraction being a function of the first member, the extraction being a semi-supervised process operable to identify the second member from the patient data comprising data for a plurality of patients, at least some of the data subjected to the semi-supervised process being free text with medical information related to symptoms, medication, test result, condition, disease, or combinations thereof; and
a display operable to output a listing of members of the medical entity class, the members comprising the at least first member and the at least second member extracted by the processor as a function of the first member.

2. The system of claim 1 wherein the free text comprises natural language information from a medical professional, the information including a misspelling, non-grammatical format, different formats, or combinations thereof.

3. The system of claim 1 wherein the processor or another processor is operable to learn from the patient data a model for determining a patient state, the learning being a function of the members, and wherein the display or another display is operable to output the patient state for at least one patient.

4. The system of claim 1 wherein the semi-supervised process uses lexical surface form features.

5. The system of claim 4 wherein the semi-supervised process identifies the second member as being in a list with the first member.

6. The system of claim 4 wherein the semi-supervised process identifies the second member as being in a similar contextual pattern as the first member.

7. The system of claim 5 wherein the semi-supervised process identifies a third member as being in a similar contextual pattern as the first member.

8. The system of claim 1 wherein the processor is operable to extract at least a third member as a function of the second member in an iteration of the semi-supervised process performed after extracting the second member, and wherein the processor is operable to deselect at least one of the second and third members from the listing as a function of a heuristic.

9. The system of claim 1 wherein the semi-supervised process is free of syntactical parsing.

10. The system of claim 1 wherein the second member comprises a rephrasing of the first member, the medical entity class comprises a canonical entity, and the listing of members is different for different datasets from respective different medical institutions, the different datasets associated with different numbers of patients.

11. In a computer readable storage medium having stored therein data representing instructions executable by a programmed processor for identifying a set of words or phrases for a canonical entity, the instructions comprising:
receiving at least one initial word or phrase;
identifying the set with lexical surface form features from free text without syntactical parsing of the free text, the identifying being a function of the at least one initial word or phrase; and
outputting the set.

12. The computer readable storage medium of claim 11, wherein the at least one initial word or phrase comprises a first plurality of medical terms, and wherein the identifying comprises identifying a second plurality of medical terms with similar context as the medical terms of the first plurality in the free text, the free text comprising medical transcripts.

13. The computer readable storage medium of claim 11 wherein identifying with lexical surface form features comprises identifying a list including the at least one initial word or phrase as a function of commas and a conjunction term, the set being populated with the at least one initial word or phrase and other words or phrases in the list.

14. The computer readable storage medium of claim 11 wherein identifying with lexical surface form features comprises:
identifying a prefix phrase, a suffix phrase, or both in a clause delimited by punctuation and including the at least one initial word or phrase, and
identifying other words or phrases with a same or similar prefix phrase, suffix phrase or both in a clause delimitated by punctuation, the other words or phrases being added to the set.

15. The computer readable medium of claim 11 further comprising:
iteratively performing the identifying with each iteration using the set from a previous iteration as the at least one initial word or phrase; and
selecting a subset of words or phrases identified by the identifying as words or phrases of the set, the selecting being a function of a frequency ratio.

16. The computer readable medium of claim 11 wherein the identifying is a semi-supervised operation.

17. A method for extracting members of a medical canonical entity from patient data including free text, the method comprising:
receiving the free text as natural language information from medical professionals for a plurality of patients, the information including a misspelling, non-grammatical format, different formats, or combinations thereof;
receiving one or more seed medical terms, the one or more seed medical terms comprising one or more members of the medical canonical entity;
determining context for the one or more seed medical terms in the free text, the determining being free of syntactical parsing;
identifying additional medical terms as a function of the context in the free text; and
generating a list of the members of the medical canonical entity as at least some of the additional medical terms and the seed medical terms.

18. The method of claim 17 wherein determining the context comprises identifying a string of terms including at least one of the one or more seed medical terms as a function of commas and a conjunction term, and wherein identifying the additional medical terms comprises identifying other ones of the terms of the string.

19. The method of claim 17 wherein determining comprises identifying a prefix phrase, a suffix phrase, or both in a clause delimited by punctuation and including at least one of the one or more seed medical terms, and wherein identifying comprises identifying the additional medical terms as having a same or similar prefix phrase, suffix phrase or both in a clause delimitated by punctuation.

20. The method of claim 17 further comprising:
iteratively performing the determining and identifying with each iteration using the additional medical terms from a previous iteration as the seed medical terms; and
selecting a subset of the additional medical terms identified in each iteration as a function of frequency ratios of the additional medical terms.

21. The method of claim 17 wherein generating the list comprises generating the list with a precision of at least about 0.90 through five iterations.
